(19) United States
(12) Patent Application Publication
(10) Pub. No.: US 2026/0233912 A1
(43) Pub. Date: Aug. 13, 2026

(54) MULTI-COMPARTMENT DISPENSING PACKAGES FOR EASY VISUALIZATION OF MEDICATION CONTENTS THEREIN, COVER SHEET FOR SUCH PACKAGES, AND METHODS OF USE

(71) Applicant: Medi-Dose, Inc., Ivyland, PA (US)

(72) Inventors: Robert Braverman, Warrington, PA (US); Donald A. Lawson, Lansdale, PA (US)

(21) Appl. No.: 19/457,340

(22) Filed: Jan. 23, 2026

Related U.S. Application Data
(60) Provisional application No. 63/757,072, filed on Feb. 11, 2025.
(60) Provisional application No. 63/785,757, filed on Apr. 9, 2025.

(51) Int. Cl. B65D 75/36; A61J 1/03; B65B 11/52; B65D 75/52

(52) U.S. Cl. CPC B65D 75/367; A61J 1/035; B65B 11/52; B65D 75/527; A61J 2205/20

(57) ABSTRACT

A multi-compartment package for medication items is disclosed. The package includes plural individual sealed compartment units which are releasably secured to each other with each compartment unit holding a medication item therein. Each compartment unit includes a transparent flanged base and a chamber. A closure member, in the form of a frangible cover sheet is adhesively secured to a flange of each compartment unit. The cover sheet includes a background area of a first color and a second color. The background area is disposed over the chamber to enable one to readily see the item through the base against the background area. Each closure member includes plural arcuate tamper-evident cuts located adjacent respective corners of the closure member.

### CROSS-REFERENCE TO RELATED APPLICATIONS

This U.S. non-provisional application claims priority under 35 U.S.C. § 119(e) to U.S. application Ser. No. 63/757,072 filed on Feb. 11, 2025 entitled MULTI-COMPARTMENT PACKAGES FOR EASY VISUALIZATION OF MEDICATION CONTENTS THEREIN, COVER SHEET FOR SUCH PACKAGES, AND METHODS OF USE. This non-provisional application also claims priority under 35 U.S.C. § 119(e) to U.S. application Ser. No. 63/785,757 filed on Apr. 9, 2025 entitled MULTI-COMPARTMENT DISPENSING PACKAGES FOR EASY VISUALIZATION OF MEDICATION CONTENTS THEREIN, COVER SHEET FOR SUCH PACKAGES, AND METHODS OF USE. Both of these provisional applications are incorporated by reference herein.

### FIELD OF THE INVENTION

This invention relates generally to multi-compartment packages for dispensing items therefrom and more particularly to multi-compartment packages for dispensing items having tamper-evident closures.

### BACKGROUND OF THE INVENTION

The patent literature includes various patents disclosing multi-compartment packages for dispensing medications. Such packages are typically made up of a blister base formed of some thin plastic material defining a plurality of compartments in which the medication is located, and a lid or label which is adhesively secured over blister base. The lid or label commonly is in the form of a lamination of a rupturable foil with a paper layer covering the foil. The paper layer is configured to be removable, e.g., peeled off of the foil, whereupon the medication can be dispensed by pressing on the bottom of the blister to cause the medication to rupture the foil and pass therethrough. The lid or label is configured to be tamper-evident, i.e., indicate if the lid or label had been tampered with to gain access to the medication in the associated compartment. Examples of patents relating to that type of package are: U.S. Pat. No. 5,046,618 (Wood); U.S. Pat. No. 6,974,032 (Intini); U.S. Pat. No. 7,093,716 (Intini); U.S. Pat. No. 7,661,531 (Intini); U.S. Pat. No. 8,523,000 (Vovan); and U.S. Pat. No. 8,740,003 (Elliott).

In U.S. Pat. No. 3,780,856 (Braverman) there is disclosed a medicinal dispensing device which is in the form of a multi-compartment base and a lid or cover adhesively secured to the base to enclose medications in the various compartments. Each of the compartments is configured to be separated from the other compartments to provide an individual dispensing unit (sometimes referred to as a unit-dose package), with the lid of each unit being configured to be peeled off the base of the unit to provide access to the medication, without requiring the medication to be pushed through the lid. In particular, the base of the package of that patent is in the form of a plurality of flanges having corners and which are detachably connected to each other along predefined frangible lines so that each flange may be separated from the remaining flanges to form an individual dispensing unit. Each dispensing unit includes a chamber with an outer opening depending from the flange of the unit. The chamber is adapted to hold a drug, tablet, capsule, etc., in it. A continuous closure member is provided covering the chamber openings, with selected portions of the interior surface of the closure member being in contact with the flanges. The closure member is perforated along selected lines corresponding to the frangible flange lines of the base member. Portions of the interior surface of the closure member corresponding to the flanges are provided with a tacky adhesive coating which is in contact with the flanges to releasably secure the closure member onto the base member, such that each chamber and its surrounding flange is covered by a respective portion of the cover member to form a sealed compartment. Other areas of the interior surface of the closure member are non-tacky, e.g., include a liner patch, and cover the chamber openings. The sealed compartments are configured to be separated from each other along their frangible flange lines to produce separate sealed compartment units. At least one corner of each flange includes a cut-away area so that the existing corner of the closure member overlies the cut-away area to function as a lift tab to facilitate the removal, e.g., peeling, of the closure member from the flange of the sealed compartment unit to provide access to the contents of the chamber.

Other prior art medicinal dispensing devices, components thereof, and methods of manufacturing and assembling the same are found in the following United States Letters Patents: U.S. Pat. No. 4,122,651 (Braverman); U.S. Pat. No. 4,211,329 (Braverman); U.S. Pat. No. 4,316,541 (Braverman et al.); U.S. Pat. No. 4,322,930 (Braverman); U.S. Pat. No. 4,416,375 (Braverman et al.), U.S. Pat. No. 4,673,086 (Braverman et al.); and U.S. Pat. No. 9,963,265 (Braverman et al.).

While that prior art medicinal dispensing device of the U.S. Pat. No. 3,780,856 is eminently suitable for its intended purposes it nevertheless leaves something to be desired from the standpoint of evidencing tampering. However, U.S. Pat. No. 11,358,771 (Braverman et al.) discloses a dispensing package like the package of U.S. Pat. No. 3,780,856, but with tamper-evidence features to indicate if the package had been tampered. Those tamper-evident features are in the form of a plurality tamper-evident cuts of a generally L-shape having a pair of legs which merge at an apex, and with the apex directed toward and located closely adjacent a respective corner of the closure member. It has been determined that, depending upon variations in the manufacturing of the cover sheet of U.S. Pat. No. 11,358,771, the tamper-evident cuts may not perform as desired, thus requiring the rejection of any cover sheet whose tamper-evident cuts would not perform as desired. That issue was addressed in our U.S. Pat. No. 12,043,463 (Braverman et al.) which discloses and claims a cover sheet with arcuate tamper-evident cuts which perform as desired irrespective of variations in the manufacture of the cover sheet and thus constitutes an improvement of the tamper evident features of the cover sheet of U.S. Pat. No. 11,358,771.

Multi-compartment medicinal dispensing packages like those of the above identified patents and the '691 application as well as others which are commercially available are frequently used to package controlled medications. One potential problem with their use with such medications is that the person, e.g., the pharmacist or other health-care provider, filling the package may make an error and not fill the package correctly. For example, that person may inadvertently omit to insert the medication into one or more with the compartments before sealing the package with the cover sheet or may insert more medications into the package than is required. Thus, a need exists for a tamper-evident multi-compartment medicinal dispensing package having the ability for the person filling the package to visually ensure that all of the compartments of the package are filled appropriately. The subject invention addresses that need.

All references cited herein are incorporated herein by reference in their entireties.

### SUMMARY OF THE INVENTION

One aspect of this invention is a multi-compartment dispensing package for holding a medication item therein. The medication item has a color. The multi-compartment dispensing package comprises a base member, and a cover sheet. The base member is formed of a transparent material and has a plurality of individual compartment units releasably secured to one another and disposed in an array of plural rows and plural columns, each compartment unit comprising a flange and a chamber having an opening depending from the flange. The flange extends around the periphery of the chamber and has plural corners. The flanges are detachably connected along frangible separation lines intersecting the corners so that each compartment unit may be separated from the other compartment units. The cover sheet has a top surface and an undersurface and comprises a plurality of closure members disposed in an array of plural rows and plural columns, each of the closure members including plural corners and being releasably secured to one another along frangible separation lines intersecting the corners of the closure members. The undersurface of the cover sheet is configured to be releasably secured to the flanges of the base member, whereupon the frangible separation lines of the cover sheet are coincident with the frangible separation lines of the base member and respective ones of the closure members are releasably secured to respective ones of the compartment units to form respective sealed compartment units with the medication item disposed therein. Each of the closure members includes an undersurface having a first background area of a first color, and a second background area of a second color. The first background area and the second background area being located adjacent each other and together form a background for the visualization of the contents of the compartment unit through the base member, whereupon the color of the medication item is readily distinguishable from either the first color or the second color so that a person viewing the dispensing package through the base member can readily see the contents of each of the compartment units. The sealed compartment units are openable to enable a user to gain access to the medication item in the sealed compartment units. The sealed compartment units are configured to be detached from the other sealed compartment units.

In accordance with one preferred aspect of the multi-compartment dispensing package of this invention the releasable securement of the cover sheet to the base member is accomplished by an adhesive.

In accordance with another preferred aspect of the multi-compartment dispensing package of this invention the first and second background areas have an adhesive thereon and the multi-compartment dispensing package additionally comprises respective patches formed of a non-stick liner covering the adhesive. The respective patches themselves bear the first and second background areas thereon or are transparent or translucent to enable first and second background areas of the first and second colors located on the undersurface of the cover sheet to be visible therethrough.

In accordance with another preferred aspect of the multi-compartment dispensing package of this invention the first color of the first background area and the second color of the second background area are printed on the respective patches.

In accordance with another preferred aspect of the multi-compartment dispensing package of this invention the first and second background areas do not have an adhesive thereon.

In accordance with another preferred aspect of the multi-compartment dispensing package of this invention the first background area and the second background area are located over the opening in the base member.

In accordance with another preferred aspect of the multi-compartment dispensing package of this invention the top surface of the cover sheet is formed of paper and the undersurface is formed of a metal foil.

In accordance with another preferred aspect of the multi-compartment dispensing package of this invention the first color is white and the second color is black.

Another aspect of this invention is a cover sheet for a multi-compartment dispensing package for holding a medication item having a color therein. The package includes a base member having a plurality of transparent individual compartment units releasably secured to one another by frangible lines and disposed in an array of plural rows and plural columns, each compartment unit comprises a flange and a chamber having an opening depending from the flange. Each flange has plural corners, with the flanges being detachably connected along frangible separation lines intersecting the corners so that each compartment unit may be separated from the other compartment units. The cover sheet has a top surface and an undersurface and comprising a plurality of closure members disposed in an array of plural rows and plural columns. Each of the closure members includes plural corners and are releasably secured to one another along frangible separation lines intersecting the corners of the closure members. The undersurface of the cover sheet is configured to be releasably secured to the flanges of the base member, whereupon the frangible separation lines of the cover sheet are coincident with the frangible lines of the base member and respective ones of the closure members are releasably secured to respective ones of the compartment units. Each of the closure members includes an undersurface having a first background area of a first color, and a second background area of a second color. The first background area and the second background area are located adjacent each other and together form a background for the visualization of the contents of the compartment unit through the base member when the cover sheet is secured to the base member, whereupon the color of the medication item is readily distinguishable from either the first color or the second color so that a person viewing the dispensing package through the base member can readily see the contents of each of the compartment units.

In accordance with one preferred aspect of the cover sheet of this invention the cover sheet has an adhesive thereon. The adhesive is configured to releasably secure the cover sheet to the base member.

In accordance with another preferred aspect of the cover sheet of this invention the cover sheet additionally comprising respective patches formed of a non-stick liner covering the adhesive. The respective patches bear the first and second background areas thereon or are transparent or translucent to enable first and second background areas of the first and second colors located on the undersurface of the cover sheet to be visible therethrough.

In accordance with another preferred aspect of the cover sheet of this invention the first color of the first background area and the second color of the second background area are printed on the undersurface of the cover sheet.

In accordance with another preferred aspect of the cover sheet of this invention the first color of the first background area and the second color of the second background area are printed on the respective patches.

In accordance with another preferred aspect of the cover sheet of this invention the first and second background areas do not have an adhesive thereon.

In accordance with another preferred aspect of the cover sheet of this invention the top surface of the cover sheet is formed of paper and the undersurface is formed of a metal foil.

Another aspect of this invention is a method of filling a multi-compartment dispensing package with a medication item having a color. The method comprising providing a multi-compartment dispensing package having a base member and a cover sheet. The base member is formed of a transparent material and has a plurality of individual compartment units releasably secured to one another and disposed in an array of plural rows and plural columns, with each compartment unit comprising a flange and a chamber having an opening depending from the flange. The flanges are detachably connected along frangible separation lines intersecting the corners so that each compartment unit may be separated from the other compartment units. The cover sheet has a top surface and an undersurface and comprises a plurality of closure members disposed in an array of plural rows and plural columns. Each of the closure members includes plural corners and are releasably secured to one another along frangible separation lines intersecting the corners of the closure members. Each of the closure members includes an undersurface having a first background area of a first color, and a second background area of a second color. The first background area and the second background area are located adjacent each other and together form a background for the visualization of the contents of the compartment unit. A medication item is introduced through each of the openings in the base member into each of the chambers of the base member. The undersurface of the cover sheet is releasably secured to the flanges of the base member, whereupon the frangible separation lines of the cover sheet are coincident with the frangible separation lines of the base member and respective ones of the closure members are releasably secured to respective ones of the compartment units to form respective sealed compartment units with the medication items disposed therein. The multi-compartment dispensing package is oriented so that the medication items in the compartments can be viewed through the transparent base with the medication items in the compartment units appearing in front of the background, whereupon the color of each medication item is readily distinguishable from either the first color or the second color so that a person viewing the dispensing package through the base member can readily see the contents of each of the compartment units.

In accordance with one preferred aspect of the method of this invention the undersurface has an adhesive thereon. The adhesive is configured to releasably secure the cover sheet to the base member.

In accordance with another preferred aspect of the method of this invention the cover sheet is initially provided with a liner sheet adhesively secured to the undersurface by the adhesive. The method additionally comprises removing the liner sheet from the cover sheet to expose the adhesive before securing the cover sheet to the base member.

In accordance with another preferred aspect of the method of this invention the liner sheet comprises plural patches of non-stick material which remain in place over the openings of the base member when the cover sheet is releasably secured to the flanges of the base member.

In accordance with another preferred aspect of the method of this invention the first and second background areas are printed on the plural patches or are printed on the undersurface of the cover sheet and the plural patches are transparent or translucent to enable first and second background areas of the first and second colors located on the undersurface of the cover sheet to be visible therethrough.

### DESCRIPTION OF THE DRAWING

FIG. 1 is an isometric view of one exemplary embodiment of a tamper-evident multi-compartment dispensing package constructed in accordance with this invention, wherein the package includes a frangible cover sheet made up of plural closure members and a frangible multi-compartment transparent base on which the cover sheet is adhesively secured, with the coversheet including visual indication means on its underside or undersurface to facilitate the visualization of the contents of the compartment through the base;

FIG. 2 is an isometric view of cover sheet of FIG. 1 in position about to be secured onto the multi-compartment base to seal the contents, e.g., medications, of the compartments making up the base within those compartments;

FIG. 3 is an enlarged top plan view of the frangible cover sheet shown in FIGS. 1 and 2;

FIG. 4 is a bottom plan view of the frangible cover sheet shown in FIGS. 1 and 2, after removal of a liner sheet used to protect the adhesive on the underside or undersurface of the cover sheet until the cover sheet is ready for securement to the base;

FIG. 5 is a greatly enlarged sectional view taken along line 5-5 of FIG. 3;

FIG. 6 is a greatly enlarged sectional view taken along line 6-6 of FIG. 3;

FIG. 7 is an enlarged side elevational view, partially broken away, taken along line 7-7 of FIG. 2 and showing a portion of the multi-compartment base;

FIG. 8 is an enlarged top plan view of one separated sealed compartment of the dispensing package of FIG. 1;

FIG. 9 is a bottom plan view of the assembled package of FIG. 1 when viewed through the base, wherein the medication contents of each of the various compartments, e.g., an elongated pill which is white or light in color, can readily be seen against the background of the undersurface of the cover sheet;

FIG. 10 is a reduced bottom plan view that is similar to FIG. 9 but showing another type of medication, e.g., a white or light-color round pill, against a black or dark-color background area of the subject invention to more dramatically illustrate the effectiveness of the subject invention in the visualization of the contents of the package when viewed through the base

FIG. 11 is a reduced bottom plan view that is similar to FIG. 11 but showing still another type of medication, e.g., a dark-color round pill, against a white or light-color background area of the subject invention to more dramatically illustrate the effectiveness of the subject invention in the visualization of the contents of the package when viewed through the base;

FIG. 12 is a plan view of the undersurface of an alternative cover sheet constructed in accordance with this invention; and

FIG. 13 is a plan view similar to FIG. 12 of the undersurface of the alternative cover sheet of FIG. 12 after an alternative liner sheet constructed in accordance with this invention has been removed leaving plural liner patches on the undersurface of the cover sheet.

### DETAILED DESCRIPTION OF THE PREFERRED EMBODIMENTS

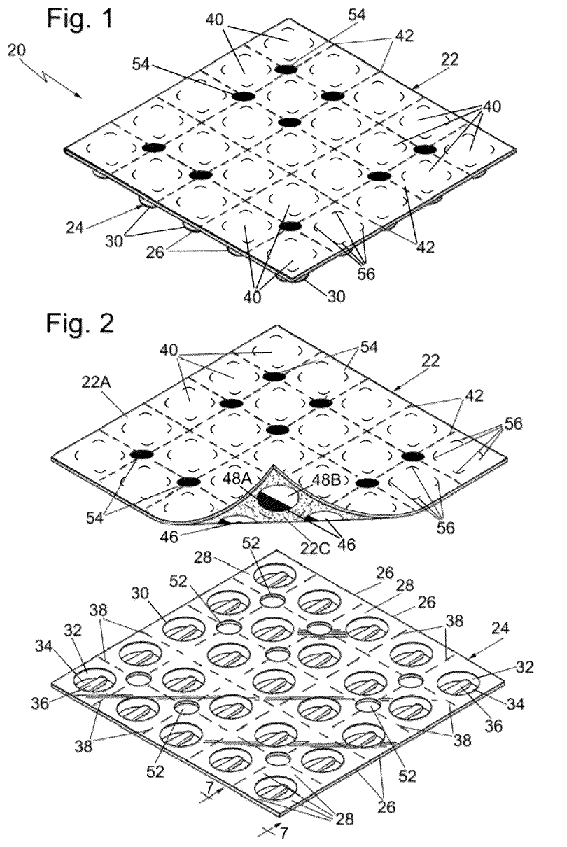

Referring now to the various figures of the drawing wherein like reference characters refer to like parts, there is shown in FIG. 1 one exemplary embodiment of a multi-compartment dispensing package 20 constructed in accordance with this invention. The multi-compartment package basically comprises a cover sheet 22 and a base member 24.

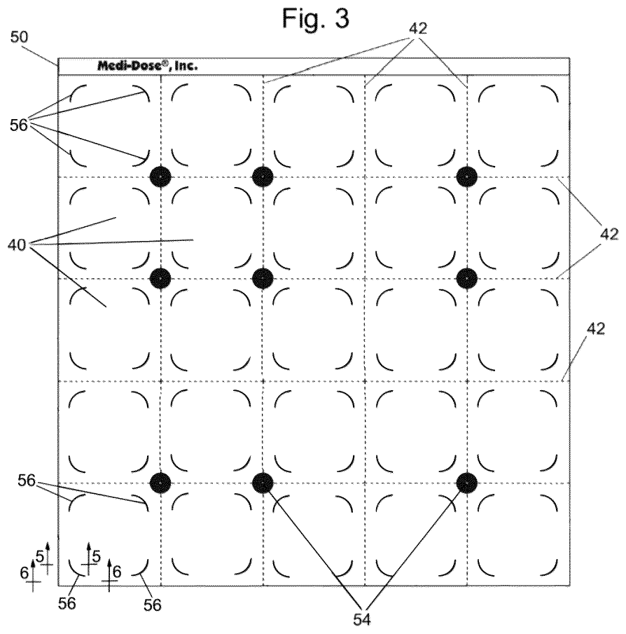

The base member 24 is best seen in FIGS. 2, 7 and 9 and includes plural “blister” compartment units 26, each of which is of square profile having a generally planar flange 28 from which a hollow chamber 30 depends downwardly. In this exemplary embodiment each compartment unit is approximately 3 cm by 3 cm square. As best seen in FIG. 3, each chamber 30 is of circular profile, e.g., of 2.2 cm diameter, and includes a downwardly extending tapering circular sidewall 32 (FIG. 7) which terminates at a generally planar bottom wall 34. The exemplary embodiment of the package 20 is configured particularly for holding one or more controlled medications or drugs, whether in the form of pills, tablets, capsules, etc., but can also be used for other items, including liquids, ointments, lotions, botanicals desired to be packaged for dispensing. The exemplary items shown held in the package are in the form of tablets 36. In the embodiment shown each of the tablets is light in color or white but could be of any color or shade.

The flanges 28 of the compartment units 26 are releasably connected to one another by plural intersecting parallel linear frangible lines 38. In the preferred exemplary embodiment of the package 20 shown in FIG. 1, the package includes twenty-five compartment units 26 disposed in an array of five rows of five columns, with the frangible lines 38 establishing the rows and columns of the array. The compartments units are formed of any suitable material, e.g., a plastic, like that of the blister compartments of the prior art patents cited above.

Each of the compartment units 26 is configured to be covered and sealed by a respective correspondingly shaped and sized closure member 40. In particular, the closure members 40 form respective portions of the cover sheet 22. As best seen in FIGS. 1-4 the cover sheet 22 is a generally planar member of square profile that includes twenty-five closure members 40 disposed in an array of five rows and five columns. The array of closure members is established by plural parallel intersecting linear frangible line 42. The cover sheet is coextensive in size with the base member 24 and the frangible lines 42 of the cover sheet are coincident with the frangible lines 38 of the base member.

In accordance with a preferred aspect of this invention and as best seen in FIGS. 5 and 6 the cover sheet 22 is preferably formed as a multi-layer construction or lamination (to be described later). Suffice it for now to state that the cover sheet 22 has an outside layer 22A, which is composed of paper, and which forms the top surface of the cover sheet, with a metal foil layer 22B disposed under the outside paper layer. The undersurface of the foil layer 22B includes a layer of a releasably securable adhesive 22C extending across the entire undersurface of the foil layer, except for circular areas 46 (to be described later) which are in the center of each closure member 40 and which are located over the chambers 30. In particular, the layer of releasably securable adhesive is in the form of a patterned adhesive. By that it is meant that the adhesive is applied in a pattern on the undersurface of the foil layer so that it is located only in the areas where the flanges 28 of the base member 24 are located and not on the circular areas 46. In particular, in accordance with one preferred aspect of producing the cover sheet of this invention the adhesive is applied across the entire undersurface of the cover sheet, e.g., the undersurface of the foil layer. Then the circular, colored areas 46 are printed on the adhesive using an adhesive-deadening ink. That action renders the surface of the areas 46 non-tacky. Accordingly, the portions of the undersurface of the foil layer within the bounds of the flange engaging portions of the cover sheet (i.e., the portions of the undersurface of the foil which will overlie the openings to the chambers), will be devoid of functioning adhesive, so that such areas can be considered as having no adhesive thereon.

The adhesive 22C on the undersurface of the cover sheet serves to releasably secure each closure member to a respective one of the compartment units 26 when the cover sheet 22 is secured to the base member 24 (as will be described later). Before the cover sheet is secured to the base member, the outer surface (i.e., the undersurface) of the adhesive layer 22C is covered and protected by a releasably securable liner sheet 44. The liner sheet 44 is a continuous member without any die cuts in it (as will be described later) and serves to keep the adhesive clean and sticky so that it can be releasably secured to the base member when desired. The cover sheet is configured so that it can be readily removed, e.g., peeled off, of the adhesive 22C to expose that adhesive.

As mentioned above the circular areas 46 on the undersurface of the foil layer 22B are printed with an adhesive-deadening ink. In particular, each of the circular areas 46 of each closure member 40 includes a first semi-circular area 48A which is printed with an adhesive-deadening ink of a first color, e.g., black, and a second semi-circular areas 48B of which is printed with an adhesive-deadening ink of a second and visually distinctive second color, e.g., white. The areas 48A and 48B conjoin together to form the heretofore identified circular area 46. That area is disposed over and coextensive in size with the circular chamber 30 and form a background against which the tablet 36 can be viewed through the transparent base member after the cover sheet has been secured to the base member so that one viewing the package through the base member can readily see if the contents of the chambers have been filled appropriately. Moreover, since each of the circular areas 46 does not include any adhesive on it the tablet 36 (or any other medication which may be in the associated chamber) will not stick to the undersurface of the closure member 40 when it is secured in place over the chamber.

After the chambers 30 in the base member have been filled with the items 36, like shown in FIG. 2, and just before the cover sheet is to be releasably secured to the base member, the liner sheet 44 is removed, e.g., peeled off, of the undersurface of the foil layer 22B by grasping a marginal edge strip 50 (FIG. 3) of the cover sheet and pulling it away from the remaining portion of the liner sheet 44, thereby exposing the adhesive on the undersurface. The cover sheet 22 can then be releasably secured to the base member by the exposed adhesive 22C of the cover sheet 22 engaging the flanges 28 of the compartment units 26 of the base member 24. This action seals the items in each of the compartment units 26, thereby completing the package 20 so that it is now in the form of plural sealed compartment units which are releasably secured to one another. As mentioned above, each circular area 46 is coincident in size to the opening of the chamber 30 over which it is disposed and does not have any adhesive on it so that the tablet 36 (or any other medication which may be in the chamber) will not stick to the undersurface of the closure member 40 when it is secured in place over the chamber.

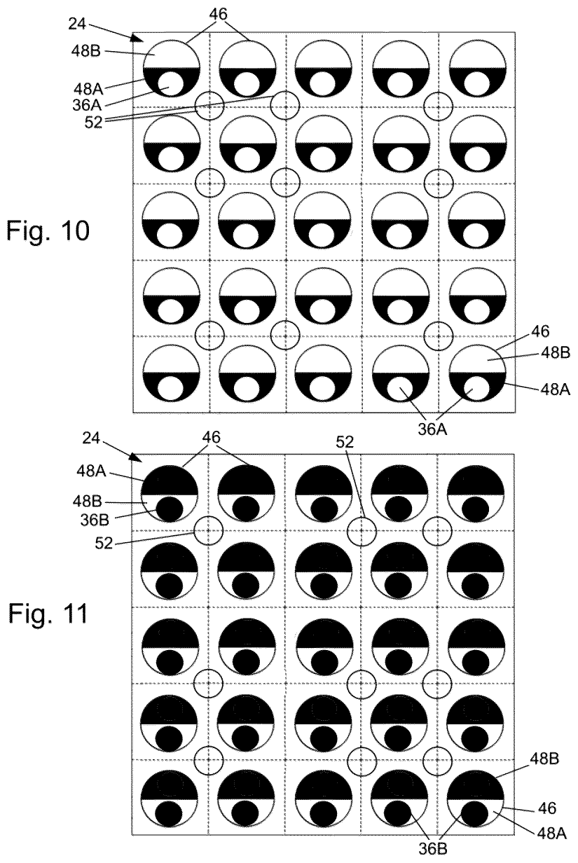

To ensure that the package 20 has been filled appropriately after the cover sheet is secured to the base member as just described, the package can be inverted so that the base member faces upward. In that orientation any person, e.g., the pharmacist who has filled the package (or any other person viewing the package through the base member), can readily see if each compartment in the package is filled appropriately with the desired medication item(s). In particular, the color of each medication item 36 will readily show up against either the color of the background area 48A or the color of the background area 48B. As can be seen in FIG. 9 each white (or light-color) tablet 36 is readily visible against the dark, e.g., black, background area 48B. FIG. 10 shows a package 20 constructed in accordance with this invention filled with another type of medication, e.g., a white or light-color round pill 36A, with the base member facing upward and with each pill 36A being located against the black or dark-color background area 48A. The location of the pill 36A on the background area 48A as shown in FIG. 10 dramatically illustrates the effectiveness of the subject invention in the visualization of the pill contents of the package when viewed through the base. FIG. 11 shows the package 20 filled with another type of medication, e.g., a dark-color round pill 36B. In that figure the pill is located so that it is against the white or light-color background area 48B to also dramatically illustrate the effectiveness of the subject invention in the visualization of the contents of the package when viewed through the base.

As mentioned earlier the exemplary embodiment of the cover sheet 44 is a continuous sheet. As such, that embodiment does not include any die-cut circular patches such as those identified by the reference number 48 of the cover sheet of our U.S. Pat. No. 12,043,46. Those circular patches serve to isolate the adhesive on the undersurface of the foil layer from the interior of the chamber of the base so that the medication in the chamber will not be exposed to any adhesive. Since the areas 46 of the embodiment of the cover sheet 22 described above are not tacky, circular liner patches like those of that patent, are not needed to protect the medication of the package of this invention from contacting an adhesive.

As an alternative to the cover sheet 22 and liner sheet 44 described above, the cover sheet 22 may be modified to form a modified embodiment of the cover sheet 22′ shown in FIG. 12. In that case the liner sheet of the cover sheet 22′ is replaced by an alternative liner sheet 44′. In the interest of brevity, the common features of the alternative cover sheet 22′ and the cover sheet 22 as described earlier, will be given the same reference numbers and the details of the construction, arrangement and operation of those features will not be reiterated. In particular, the modified embodiment of the cover sheet includes the adhesive 22C extending across the entire undersurface of its foil layer 22B. Moreover, the undersurface of the foil layer 22B is not printed with an adhesive deadening ink (or any ink) to provide the colored areas 48A and 48B for effecting the easy visualization of the contents of the compartments through the base member as described above. Instead, the liner sheet 44′ includes portions which provide the colored areas 48A and 48B.

As best seen in FIG. 12, the liner sheet 44′ is similar in construction to the liner sheet 44 except for the inclusion of die-cut circles 62 to be described shortly. In the interest of brevity, the common features of the alternative liner sheet 44′ and the liner sheet 44 will be given the same reference numbers and the details of the construction, arrangement and operation of those features will not be reiterated. Suffice for now to state that the liner sheet 44′ like the liner sheet 44 serves to protect the adhesive 22C on the underside of the cover sheet 22′ until the cover sheet is ready for securement to the base member 24. Each die cut circle 62 forms a respective liner patch 48′ Each liner patch 48′ is similar to liner patches 48 of U.S. Pat. No. 12,043,463 but is modified so that the undersurface of the patch 48′ is printed with the distinctive colors to form the background area 46. In particular, the undersurface of each patch 48′ includes the heretofore first semi-circular area 48A which is printed with an ink of a first color, e.g., black, and a second semi-circular areas 48B of which is printed with an ink of a second and visually distinctive second color, e.g., white. The areas 48A and 48B conjoin together to form the heretofore identified printed circular area 46.

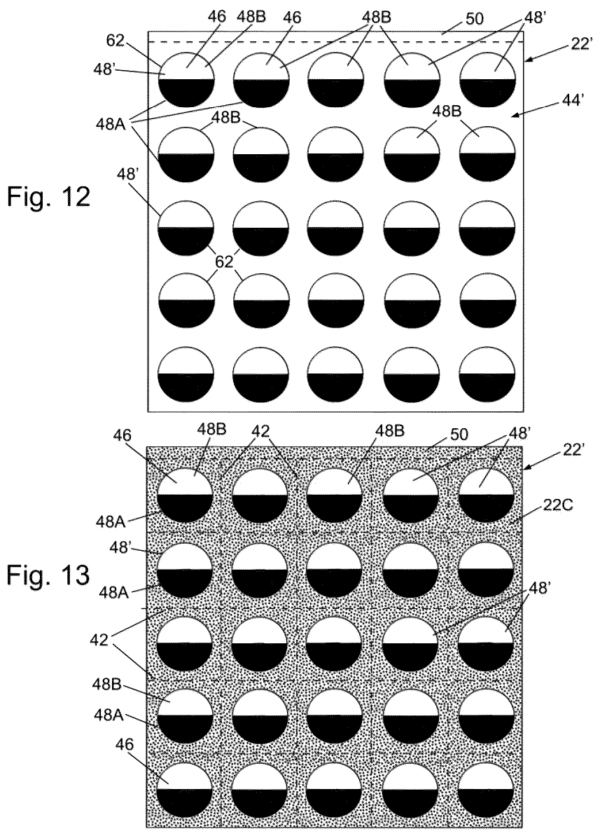

Use of the variant cover sheet 22′ is follows. After the chambers 30 in the base member have been filled with the items 36, and just before the cover sheet is to be releasably secured to the base member, the liner sheet 44′ is removed, e.g., peeled off, of the undersurface of the foil layer 22B by grasping a marginal edge strip 50 of the cover sheet and pulling it away from the remaining portion of the liner sheet 44′, thereby leaving the liner patches 48′ in place on the cover sheet 22′, with portions of the adhesive 22C not covered by the patches exposed as clearly shown in FIG. 13.

The securement of the cover sheet 22′ to the base member 24 can then be accomplished by juxtaposing the cover sheet with the exposed adhesive with respect to the flanges 28 of the base member in the same manner as described above with respect to the securement of the cover sheet 22 to the base member 24. This action seals the items 36 in each of the compartment units 26, thereby completing the package 20 so that it is now in the form of plural sealed compartment units which are releasably secured to one another. Since each liner patch 48′ is coincident in size to the opening of the chamber 30 over which it is disposed, no portion of the adhesive on the undersurface of the foil layer will be exposed to the item within the chamber. Moreover, the background area 46 and its component areas 48A and 48B provided by each liner patch 48′ forms a background against which the medication item, e.g., tablet 36, can be viewed through the transparent base member after the cover sheet has been secured to the base member.

It should be noted that in lieu of the liner patches 48′ bearing the printed ink areas on their undersurface, the liner patches 48′ may be formed of a transparent or translucent material, e.g., the entire liner sheet 44′ being formed of such a material. In that case the undersurface of the foil layer 22B can be printed with an ink to form the first and second printed areas 48A and 48B thereon, so that when the transparent or translucent liner patches are secured to the undersurface of the foil layer 22B of the cover sheet those printed ink areas are visible through the liner patches.

Use of the package 20 to dispense the item 36 held within any of the sealed compartment units 26 is as follows. The sealed compartment may be separated from the remaining compartments of the base member by tearing or otherwise breaking the coincident frangible lines 42 and 38 which connect that unit to the remaining units. That action results in a separated sealed compartment unit. To provide access to the item within the chamber of that compartment unit the closure member 40 which is adhesively secured to the flange 28 of that compartment unit must be removed, e.g., lifted and peeled off, of the flange. In order to facilitate the lifting of the closure member off of the flange, each flange includes at least one corner that is cut away to enable a user to gain access to the underside or undersurface of the closure member 22 to serve as a lift tab peel the closure member up and away from flange to open the sealed compartment containing the item 36 to be accessed.

In accordance with one preferred aspect of this invention, if the package is in the form of a five-by-five array of compartment units 26, like in the exemplary embodiment 20 shown, at nine of the intersections of the frangible lines 38 of the base member 24 there are provided punched openings 52. The punched openings are in the form of circles but could be of other shapes. In any case, the punched openings are arranged as set forth in our U.S. Pat. No. 3,780,856 (Braverman). Each punched opening 52 acts as a cutaway area for the four flanges meeting at the intersection of the frangible lines at which the opening is located. Those nine punched openings 52 thus provide at least one cut-away area for each of the twenty-five flanges of the base member to facilitate the removal, e.g., peeling off, of the closure member on the compartment holding the item to be accessed. With the openings arranged as shown the base member can include a minimum number, e.g., nine, of openings, yet one corner of each flange will be cutaway so that the corner of the closure member releasably secured to the flange is always free of the flange where the punched opening is located. In this way, a corner of each closure member 40 is always readily accessible for lifting to facilitate the separation of the closure member from the flange when a user desires to gain access to the item 36 held in the associated chamber.

As best seen in FIG. 2, in the exemplary embodiment of the package 20 the openings 52 are located at the intersection of the first (topmost) row and first (leftmost) column, at the intersection of the second row and first column, at the intersection of the fifth row and first column, at the intersection of the first row and the second column, at the intersection of the second row and the second column, at the intersection of the fifth row and the second column, at the intersection of the first row and the fifth column, at the intersection of the second row and the fifth column, and at the intersection of the fifth row and the fifth column.

The cover sheet 22 includes indicia, e.g., circular dots 54, located at nine intersections of the frangible lines 42, so that when the cover sheet is secured to the base member the dots overlie respective ones of the punched openings 52 of the base. Thus, when an individual sealed compartment is separated from the remainder of the compartments of the package 20, a quarter sector of a dot 54 will be located in the corner of the closure member of the separated sealed compartment overlying the cutaway portion of the unit to indicate to the user which corner of the closure member should be lifted to provide access to the item in the chamber.

In the interest of safety each of the closure members is tamper evident, so that if anyone attempted to tamper with the package, e.g., peel any portion of the cover sheet off of the base member after the compartments of the base member have been filled with items and the cover sheet secured to the flanges of the base member, such tampering would be readily evident. In particular, each closure member includes four tamper-evident cuts 56 arranged in a square array, with each cut being located closely adjacent a respective corner of the closure member.

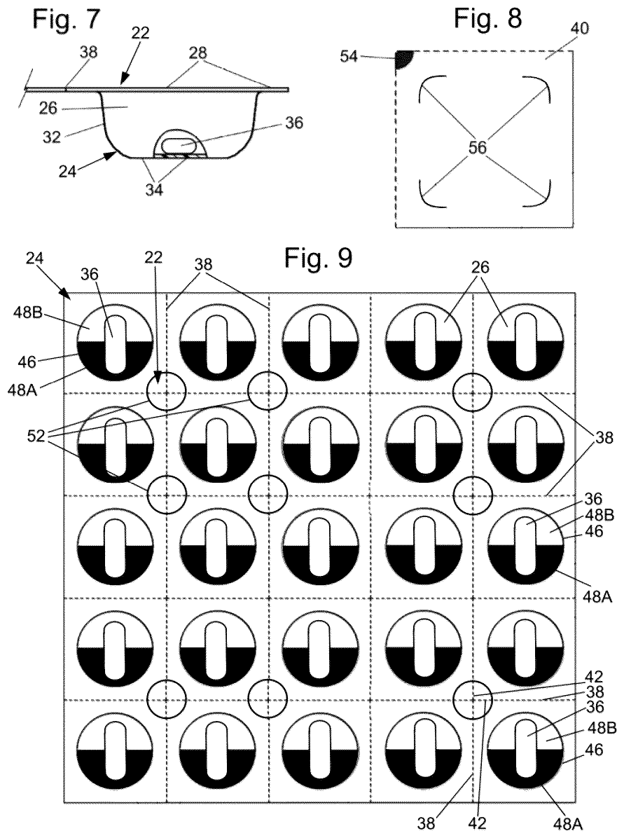

As best seen in FIGS. 1, 3 and 8, each tamper-evident cut is of an arched or arcuate shape, e.g., an arc of a circle, such that it includes an apex located facing the adjacent corner of the closure member and leg portion or legs located on opposite sides of the apex. In accordance with one preferred aspect of this invention the arch-shaped tamper-evident cuts are symmetrical in shape, i.e., the length and shape of both legs is identical. It is preferred, but not mandatory, that the tamper-evident cuts are each an arc of a circle having a constant or fixed radius of curvature. It is to be understood that the tamper-evident cuts 56 can be the rounded corners of a rectangle instead of a square. In fact, the tamper-evident cuts 56 may be of other sizes and shapes, so long as they form rounded corners of a square or rectangle which is centered in its closure member. To that end, the tamper-evident cut 56 need not be arcs of a circle, but can be other shaped arcs, e.g., arcs of an oval or some other curved shape, preferably with the arcs having an apex directed or facing toward the adjacent corner of the closure member.

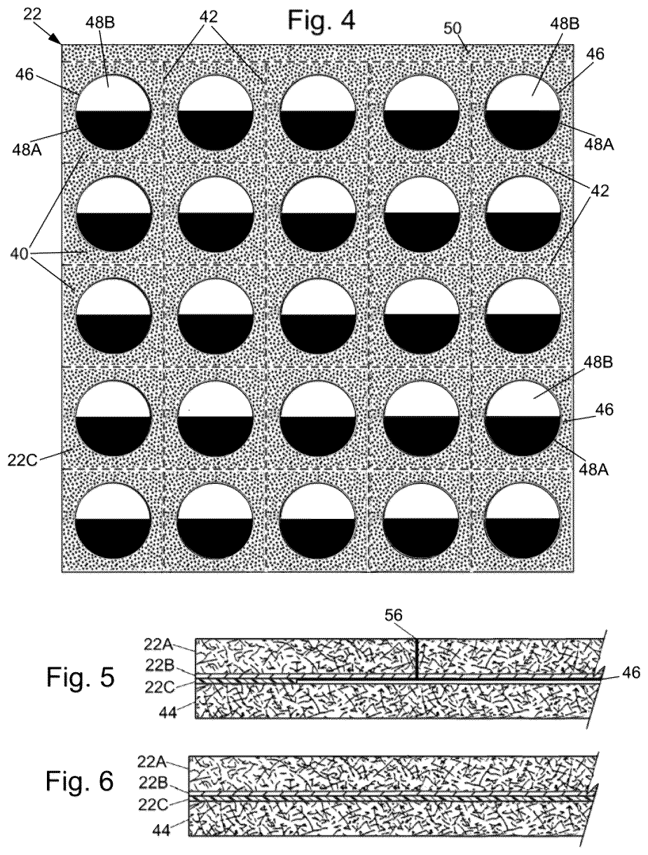

Each of the tamper-evident cuts 56 is located so that when the closure member 40 is secured to respective compartment 26 of the base member 24, each cut is disposed over a respective portion of the underlying flange 28. Each of the tamper-evident 56 cuts extends at least partially through the lamination forming the cover sheet. In the exemplary embodiment shown in FIG. 4 each cut 56 extends fully through the layers 22A-22C of the cover sheet. In any case each cut provides a weakened area of the closure member at the location of the cut. Thus, if someone attempts to lift the closure member adjacent any corner the portion of the closure continuous with apex of the cut will attempt to remain secured to the flange, while the portions of the cut forming the legs of the cut start a tear, which propagates therefrom to the adjacent portion of the closure member. That tear becomes readily visible, thereby indicating attempted or actual tampering with the package has occurred.

While it is preferred that each closure member includes a tamper-evident cut adjacent each of the corners of that closure member, that need not be the case for all applications. Thus, if desired only a single corner or selected corners of the closure members may include a tamper-evident closure member.

In accordance with one preferred exemplary embodiment of this invention the combination of the layers 22A and 22B (referred to as the “face-stock”) is in the form of an inverted 0.000285-inch foil laminated to a 60 pound paper base sheet, with the basis weight of the face stock being 70 pounds per 500 sheet ream of 25 inch by 38 inch sheets. The thickness or caliper of the face-stock is 0.036 inch. The foil itself is aluminum and of a thickness or caliper of 0.000285 inch. The adhesive making up the layer 22C is an aggressive high tack permanent acrylic emulsion adhesive of 0.00085-inch thickness or caliper and having a loop tack of 4.6 pounds per square inch. The adhesive instantly adheres to many surfaces with a tamper evident bond. The release liner sheet 44 and 44′ is high bulk to weight silicone coated MG bleached Kraft paper, having a thickness or caliper of 0.0032 inch.

The base member 22 can be constructed of any suitable commercially available plastic material that exhibits good moisture resistance. Examples of some suitable materials are pharmaceutical grade thermoformable rigid PVC plastic films, like Pentapharm® PH-M57/04 film sold by Klöckner Pentaplast of America, Inc. or Pentapharm® alfoil Polymer film P-250/40 also sold by Klöckner Pentaplast of America, Inc. or thermoformable rigid PVC films like Perlalux® Mono sold by Perlen Converting AG of Perlen Switzerland or Perlalux®-Duplex 500.40 (C) UV also sold by Perlen Converting AG. Other plastic materials can be used as well, depending upon the items/products to be held within the compartments of the base member.

It must be pointed out at this juncture that the embodiments as described above are merely exemplary of various embodiments of this invention which are contemplated. For example, the compartment units may be rectangular in shape instead of the square shape shown and described above. The chambers can be of various shapes other than the circular shape as described above. Thus, the chambers can be oval or square with rounded corners or rectangular with rounded corners. The cover sheet need not be a lamination of a paper layer and a foil layer or any other combination but may be only a single layer of any suitable material. Moreover, the background areas made up of the first and second areas 48A and 48B need not be circular in shape, but can be of any shape so long as it provides a background of two visually distinctive colors against one of which the medication in the package can be readily visualized through the base member and does not include any adhesive to which the medication item can stick. Furthermore, the two colors need not be black and white, but can be any colors or shades so long as at least one of those areas will provide a distinctive background against which the color of the medication can be readily visualized through the base member. Further still, the areas 46 need not be printed on the undersurface of the cover sheet but can be applied or created through any means or process. As discussed above with respect to the embodiment of the cover sheet shown in FIGS. 12 and 13, the background areas 46 may be formed of colored patches, constructed like patches 48 of the liner sheet of U.S. Pat. No. 12,043,463 but which include first and second colored areas 48A and 48B on the undersurface thereof. Those patches can be held in place on the undersurface of the cover sheet by an adhesive, e.g., the releasably securable adhesive 22C used to secure the cover sheet to the base member. In that case the entire undersurface of the cover sheet would be covered with the layer of adhesive 22C, instead of being applied as a patterned adhesive, e.g., by the use of adhesive-deadening ink, like that disclosed with respect to the embodiment of FIGS. 1-11. Alternatively, as also discussed above, the liner patches can be transparent or translucent, with the areas 46 being printed on the undersurface of the foil layer either between the adhesive and the foil layer or on the undersurface of the adhesive on the foil layer. In the former case, the adhesive should itself be transparent or translucent to enable the ink on the undersurface of the foil layer to be visible through the adhesive and then through the transparent or translucent liner patches. In lieu of printing the areas 48A and 48B on the undersurface of the foil layer or on the undersurface of the adhesive, the areas 48A and 48B can be printed on the inner surface of the liner patch itself, i.e., the surface of the liner patch which is adhesively secured to the adhesive on the foil layer, providing that the material making up the liner patch is transparent or translucent so that the printed areas on the inner surface of the liner patch are viewable through the liner patch. It should also be noted that while the embodiment disclosed above make use of base member, all portions of which are transparent or translucent to enable the contents of their chambers to be visible against the background areas provided by the cover sheet, those base member constructions are merely some examples and variations can be made to them. For example, the flanges of the base member need not be transparent or translucent, so long as the portions of the base member making up the chambers are transparent or translucent. Those transparent or translucent chamber forming portions of the base member will enable the visualization of the contents of the chambers through them.

With respect to the tamper-evident means of the cover sheet 22, it should be noted that the cover sheet need not include tamper-evident means like that disclosed, or any other type. If tamper-evident means is used and includes cuts, the shape, sizes and locations of the cuts making up such means can be altered from that shown and described above. If so, it is preferred, but not mandatory, that the cuts are configured and form some kind of tapered edge which may be a sharp point or even arcuate or curved, so that an attempt to peel or lift any portion of a closure member from the underlying compartment unit will result in a visible tear in the closure member starting at the tapered edge and propagating therefrom, thereby evidencing tampering.

Without further elaboration the foregoing will so fully illustrate our invention that others may, by applying current or future knowledge, adopt the same for use under various conditions of service.

We claim:

1. A multi-compartment dispensing package for holding a medication item therein, the medication item having a color, said multi-compartment dispensing package comprising:
a base member formed of a transparent material and having a plurality of individual compartment units releasably secured to one another and disposed in an array of plural rows and plural columns, each compartment unit comprising a flange and a chamber having an opening depending from said flange, said flange extending around the periphery of said chamber and having plural corners, said flanges being detachably connected along frangible separation lines intersecting said corners so that each compartment unit may be separated from the other compartment units; and
a cover sheet having a top surface and an undersurface and comprising a plurality of closure members disposed in an array of plural rows and plural columns, each of said closure members including plural corners and being releasably secured to one another along frangible separation lines intersecting said corners of said closure members, said undersurface of said cover sheet being configured to be releasably secured to said flanges of said base member, whereupon said frangible separation lines of said cover sheet are coincident with said frangible separation lines of said base member and respective ones of said closure members are releasably secured to respective ones of said compartment units to form respective sealed compartment units with said medication item disposed therein, each of said closure members including an undersurface having a first background area of a first color, and a second background area of a second color, said first background area and said second background area being located adjacent each other and together forming a background for the visualization of the contents of said compartment unit through said base member, whereupon the color of the medication item is readily distinguishable from either said first color or said second color so that a person viewing said dispensing package through said base member can readily see the contents of each of said compartment units, the sealed compartment units being openable to enable a user to gain access to the medication item in said sealed compartment units, said sealed compartment units being configured to be detached from said other sealed compartment units.

2. The multi-compartment dispensing package of claim 1 wherein said releasable securement of said cover sheet to said base member is accomplished by an adhesive.

3. The multi-compartment dispensing package of claim 2 wherein said first and second background areas have an adhesive thereon and said multi-compartment dispensing package additionally comprises respective patches formed of a non-stick liner covering said adhesive, said respective patches themselves bearing said first and second background areas thereon or being transparent or translucent to enable first and second background areas of said first and second colors located on said undersurface of said cover sheet to be visible therethrough.

4. The multi-compartment dispensing package of claim 3 wherein said first color of said first background area and said second color of said second background area are printed on said respective patches.

5. The multi-compartment dispensing package of claim 2 wherein said first and second background areas do not have an adhesive thereon.

6. The multi-compartment dispensing package of claim 1 wherein said first background area and said second background area are located over said opening in said base member.

7. The multi-compartment dispensing package of claim 1 wherein said top surface of said cover sheet is formed of paper and said undersurface is formed of a metal foil.

8. The multi-compartment dispensing package of claim 1 wherein said first color is white and said second color is black.

9. A cover sheet for a multi-compartment dispensing package for holding a medication item having a color therein, the package includes a base member having a plurality of transparent individual compartment units releasably secured to one another by frangible lines and disposed in an array of plural rows and plural columns, each compartment unit comprising a flange and a chamber having an opening depending from the flange, each flange has plural corners, with the flanges being detachably connected along frangible separation lines intersecting the corners so that each compartment unit may be separated from the other compartment units, said cover sheet having a top surface and an undersurface and comprising:
a plurality of closure members disposed in an array of plural rows and plural columns, each of said closure members including plural corners and being releasably secured to one another along frangible separation lines intersecting said corners of said closure members, said undersurface of said cover sheet being configured to be releasably secured to the flanges of the base member, whereupon said frangible separation lines of said cover sheet are coincident with the frangible lines of the base member and respective ones of said closure members are releasably secured to respective ones of the compartment units, each of said closure members including an undersurface having a first background area of a first color, and a second background area of a second color, said first background area and said second background area being located adjacent each other and together forming a background for the visualization of the contents of the compartment unit through the base member when said cover sheet is secured to the base member, whereupon the color of the medication item is readily distinguishable from either said first color or said second color so that a person viewing the dispensing package through the base member can readily see the contents of each of the compartment units.

10. The cover sheet of claim 9 wherein said cover sheet has an adhesive thereon, said adhesive being configured to releasably secure said cover sheet to said base member.

11. The cover sheet of claim 10 additionally comprising respective patches formed of a non-stick liner covering said adhesive, said respective patches bearing said first and second background areas thereon or being transparent or translucent to enable first and second background areas of said first and second colors located on said undersurface of said cover sheet to be visible therethrough.

12. The cover sheet of claim 9 wherein said first color of said first background area and said second color of said second background area are printed on said undersurface of said cover sheet.

13. The cover sheet of claim 11 wherein said first color of said first background area and said second color of said second background area are printed on said respective patches.

14. The cover sheet of claim 9 wherein said first and second background areas do not have an adhesive thereon.

15. The cover sheet of claim 9 wherein said top surface of said cover sheet is formed of paper and said undersurface is formed of a metal foil.

16. A method of filling a multi-compartment dispensing package with a medication item having a color, the method comprising:
providing a multi-compartment dispensing package having a base member and a cover sheet, said base member being formed of a transparent material and having a plurality of individual compartment units releasably secured to one another and disposed in an array of plural rows and plural columns, each compartment unit comprising a flange and a chamber having an opening depending from said flange, said flanges being detachably connected along frangible separation lines intersecting said corners so that each compartment unit may be separated from the other compartment units, said cover sheet having a top surface and an undersurface and comprising a plurality of closure members disposed in an array of plural rows and plural columns, each of said closure members including plural corners and being releasably secured to one another along frangible separation lines intersecting said corners of said closure members, each of said closure members including an undersurface having a first background area of a first color, and a second background area of a second color, said first background area and said second background area being located adjacent each other and together forming a background for the visualization of the contents of said compartment unit;
introducing a medication item through each of said openings in said base member into each of said chambers of said base member;
releasably securing said undersurface of said cover sheet to said flanges of said base member, whereupon said frangible separation lines of said cover sheet are coincident with said frangible separation lines of said base member and respective ones of said closure members are releasably secured to respective ones of said compartment units to form respective sealed compartment units with said medication items disposed therein; and
orienting said multi-compartment dispensing package so that said medication items in said compartments can be viewed through said transparent base with said medication items in said compartment units appearing in front of said background, whereupon the color of each medication item is readily distinguishable from either said first color or said second color so that a person viewing said dispensing package through said base member can readily see the contents of each of said compartment units.

17. The method of claim 16 wherein said undersurface has an adhesive thereon, said adhesive being configured to releasably secure said cover sheet to said base member.

18. The method of claim 17 wherein said cover sheet is initially provided with a liner sheet adhesively secured to said undersurface by said adhesive, said method comprising removing said liner sheet from said cover sheet to expose said adhesive before securing said cover sheet to said base member.

19. The method of claim 18 wherein said liner sheet comprises plural patches of non-stick material which remain in place over said openings of said base member when said cover sheet is releasably secured to said flanges of said base member.

20. The method of claim 19 wherein said first and second background areas are printed on said plural patches or are printed on said undersurface of said cover sheet and said plural patches are transparent or translucent to enable first and second background areas of said first and second colors located on said undersurface of said cover sheet to be visible therethrough.
